(19) United States
(12) Patent Application Publication
(10) Pub. No.: US 2013/0073407 A1
(43) Pub. Date: Mar. 21, 2013

(54) METHOD, REVERSE VENDING MACHINE, DATA PROCESSING UNIT AND COMPUTER PROGRAMME PRODUCT FOR INITIATING A DATA TRANSACTION IN RELATION TO A SELF-SERVICE PURCHASE

(71) Applicant: Adil Setoui, Eindhoven (NL)

(72) Inventor: Adil Setoui, Eindhoven (NL)

(73) Assignee: Re-Pay Holding B.V., Geldrop (NL)

(21) Appl. No.: 13/639,620

(22) PCT Filed: Apr. 5, 2011
(86) PCT No.: PCT/NL2011/000025

§ 371 Date: Dec. 7, 2012

(30) Foreign Application Priority Data
Apr. 6, 2010 (NL) 1037862
May 10, 2010 (NL) 1037950

(51) Int. Cl. G06Q 20/18; G06Q 20/20

(52) U.S. Cl. 705/21; 705/23

(57) ABSTRACT

A method, a reverse vending machine, a data processing unit and a computer programme product for initiating a data transaction in relation to a self-service purchase, including the splitting of or the making of a supplementary payment to a deposit credit. A first data is generated, which is representative of a first value corresponding to a deposit credit of an amount of packaging items of a user. A purchase transaction is initiated on the basis of a second data, which second data represents a second value of the purchase in question. A third data is generated if the second value is smaller than the first value, and a pay-out transaction is initiated in the form of a credit to be paid out to the user or a further purchase transaction. A fourth data is generated and a supplementary payment is started.

The invention generally relates to a method, a reverse vending machine, a data processing unit and a computer programme product for initiating a data transaction in relation to a self-service purchase of a product such as a lottery ticket, an admission ticket for a performance or the like, a credit on a prepaid phone card, etc, using a reverse vending machine.

To collect and pay out deposit money paid by a consumer on packaging items for products, such as empty bottles, crates and the like (packing), a so-called reverse vending machine is generally used in practice. Such a reverse vending machine comprises an intake unit for taking in packaging items and for generating data representative of a first value, expressed in a currency, which corresponds to the deposit credit value of an amount of packaging items taken in from a user.

After the packaging items have been returned, a data output unit of the reverse vending machine provides a voucher which represents a credit value equal to the deposit credit value of the amount of packaging items returned by the user in question. The credit in question depends on the number and the type of returned packaging items and the deposit money paid upon purchase of the goods packaged in the packaging items at a cash desk or Point Of Sale (POS) of a shop, for example a supermarket.

A consumer can use the credit on vouchers at the POS or the cash desk of a shop to obtain a discount on a purchase. Usually, the credit value of vouchers of returned packaging items can also be paid out in cash money at a POS or cash desk of a shop.

From International patent applications WO 2004/032071, WO 2006/096070 and WO 2009/041825 it is known to use the credit value calculated by a reverse vending machine directly for purchasing a product, such as a lottery ticket or a telephone card, so as to provide and extra stimulus to return empty packaging items. It is furthermore known to donate the credit value to a charitable institution or the like.

Generally the credit value of vouchers issued within the framework of a discount action or by a reverse vending machine varies from an amount in the order of ten Eurocents to more than ten Euros or a corresponding value in another currency. If the deposit credit value of the amount of packaging items taken in does not suffice for realising an intended purchase, International patent application WO 2006/096070 provides a payment unit, by means of which the deposit value can be supplemented to a value that sufficies for the purchase. This can be done by inserting cash money in the form of coins or banknotes or via a financial transaction card or the like. The reverse vending machine known from International patent applications WO 2004/032071 and WO 2009/041825 does not provide a possibility of supplementing a deposit value to an amount required for a purchase.

It has been found that the possibilities of realising a purchase with a deposit credit value at a reverse vending machine are limited not only in situations in which the credit value is too low but also in situations in which the credit value is too high.

If a user wishes to initiate a purchase via the reverse vending machine and can return an amount of packaging items having a total deposit credit value higher than the amount or the cost of the intended purchase, the user has no other option than first having the reverse vending machine take in an amount of packaging items corresponding to the purchase amount, subsequently going through and completing the purchase transaction, up to and including the actual delivery of a purchased product, and repeating these operations, if necessary, for a next purchase or spending the remainder of his packaging items via a voucher at a POS or having the credit on the voucher paid out in cash money.

A shop, such as a supermarket, generally has only one or a few reverse vending machines available for taking in packaging items. It will be understood that the above-described operations to be carried out by a user at a prior art reverse vending machine upon realising a purchase or purchases in the case of a large number of packaging items being returned are not only user-unfriendly, but that as a whole this will undeniably also lead to undesirable delays in the take-in process at a reverse vending machine.

Such delays will not only lead to long waiting queues and dissatisfied users, but the result may also be that users or consumers will avoid going to shops that have such reverse vending machines for making a purchase. Not only will the intended effect of stimulating consumers to return packaging items be lost in that case, but in addition to that a vendor of the products will not have an income, and eventually this may even have an adverse effect on the sales of the shop that operates the reverse vending machine.

Accordingly it is an object of the present invention to provide a technical solution for using the deposit credit value of an amount of packaging items taken in by a reverse vending machine in a flexible manner for a direct self-service purchase wherein the credit value of an amount of packaging items returned in one go, entirely or partially supplemented with a separate payment, can be used for settling the cost of a purchase transaction initiated via the reverse vending machine.

According to a first aspect, the invention to that end provides a method for initiating a data transaction in relation to a self-service purchase, called a purchase transaction, by means of a reverse vending machine for taking in packaging items, which reverse vending machine is provided with an intake unit for taking in packaging items and for generating first data representative of a first value, expressed in a currency, which corresponds to an amount of packaging items taken in from a user, a data input unit for user initiation of the purchase transaction and for generating purchase data, which purchase data identify a respective purchase, and second data, which second data represent a second value, expressed in the respective currency, of the purchase in question, wherein the purchase data and the second data are generated on the basis of a purchase order entered by a user via the data input unit, a data processing unit operatively connected to the intake unit and the data input unit, and a payment unit, a purchase delivery and confirmation unit and a data output unit, operatively connected to the data processing unit.

The method further comprises carrying out the following steps under the control of the data processing unit:
generating third data, on the basis of the first data and the second data, if the second value is smaller than the first value, which third data represent a third value expressed in the currency in question;
initiating, on the basis of the third data, a data transaction in relation to a credit payment, called a pay-out transaction, which pay-out transaction comprises the provision of the third data as first data for a further purchase transaction or of a credit in the currency in question to be paid out via the data output unit;
generating fourth data, on the basis of the first data and the second data, if the second value is higher than the first value, which fourth data represent a fourth value expressed in the currency in question;
initiating, on the basis of the fourth data, a data transaction in relation to a payment, called a payment transaction, which payment transaction comprises the processing by the payment unit of a payment by the user in the form of a cash payment or an electronic payment corresponding to the fourth value;
generating fifth data by forming fifth data from the first data or from the first data and the fourth data, which fifth data represent a fifth value, expressed in the currency in question, corresponding to the second value;
transferring the purchase data and the fifth data to a supplier of the purchase;
confirming and delivering the purchase, by the delivery and confirmation unit, in case of a successful transfer of the purchase data and the fifth data, and
outputting data via the data output unit.

The method according to the invention in particular provides a technical solution to the above problem of making a purchase when the voucher is higher than the purchase amount.

The first data represent the deposit credit or first value, expressed in a respective currency, calculated by the intake unit of the reverse vending machine. The second data represent the value of the purchase expressed in a respective currency. In other words, the cost of the purchase or the price of the purchase or the purchase amount.

With the reverse vending machine according to the invention, the user can have the reverse vending machine take in all the packaging items in one and the same operation. The second data are subsequently generated on the basis of a purchase order entered by a user via the data input unit. This order is the result of a purchase transaction selected by the user. Depending on the user's order, second data representing the total value of the purchase in question are generated.

If the second value is smaller than or equal to the first (credit) value, for example if the deposit credit value is higher than the value required for a respective purchase, third data representing a third (credit) value, for example the first value minus the second value, will be generated.

If the second value is higher than the first value, for example if the deposit credit value does not suffice for a respective purchase, fourth data representing a fourth value, for example the second value minus the first value, will be generated.

In the first situation, i.e. when third data are generated, the method according to the invention provides the step of initiating a data transaction in relation to a credit payment, called a pay-out transaction. The pay-out transaction comprises the provision via the data output unit of a credit to be paid out in the currency in question. This can for example take place in the form of a known deposit money voucher, as usually issued for a deposit credit by a reverse vending machine via the data output unit, for example for spending the voucher credit at a POS, or in cash via the payment unit, for example.

It is also possible, however, to use the third data as (new) first data for a further purchase or a subsequent purchase transaction, i.e. the third credit value represented by the third data can be directly used for a further purchase at the reverse vending machine. This can for example take place if the user has second thoughts and wishes to make another purchase or if purchases cannot be settled in a single purchase transaction.

Depending on whether or not expenses are charged, without additional expenses being charged, the third data will therefore represent a credit value, which is the result of the first (credit) value minus the second value i.e. minus the cost of the purchase. The user can therefore opt to spend the remaining credit, or the third data, for a directly redeemable credit or for a further purchase.

In the second situation, i.e. a situation in which the credit represented by the first data does not suffice for the intended purchase, the method according to the invention provides the step of generating fourth data. Likewise depending on whether or not additional expenses are charged, the fourth data will represent a value, without additional expenses being charged, which is the result of the second value of the purchase minus the first value. Before the purchase can be made, the method according to the invention further provides the step of the fourth data initiating a data transaction in relation to a payment, called a payment transaction, which payment transaction comprises the processing by the payment unit of a payment by the user in the form of a cash payment and/or an electronic payment.

That is, a user can raise his total credit at the reverse vending machine by making an additional payment in the form of a cash payment and/or an electronic or giro payment. The amount to be paid in that case corresponds to the fourth value in the currency in question as represented by the fourth data. Since the additional payment constitutes a credit of the user, the fourth data therefore represent a fourth credit value.

To effect the additional payment, using cash money, suitable payment machines which accept coins and/or banknotes are available in practice. Furthermore, techniques and payment machines are available in practice for carrying out electronic or giro payments, which machines are for example provided with a card reader for reading bank cards, smart cards and/or credit cards and the like. Also other payment methods which are known per se, for example payment by means of a mobile telephone application or the like, can be used for the purpose of the invention.

It will be understood that if the first value is equal to the second value, for example if the deposit credit value obtained as a result of the reverse vending machine having taken in packaging items is equal to the value required for a respective purchase, third or fourth data will not be generated.

The initiation of the purchase transaction further comprises the forming of fifth data from the first data or from the first data and the fourth data, which fifth data represent a fifth value, expressed in the currency in question, corresponding to the second value. The fifth value thus corresponds on the one hand to a part of the first value, if the first value is higher than the second value required for the actual purchase, or on the other hand to a combination of the entire first value and the fourth value if the first value is lower than the second value. The eventual credit value for the purchase is formed by the fifth data. It is noted that in the situation in which expenses are charged, the fifth value need not be equal to the second value.

In its most general form, the purchase transaction is finalized or completed by transferring the purchase data and the fifth data to a supplier of the purchase under the control of the data processing unit, and by the confirmation and delivery of the purchase by the delivery and confirmation unit in the case of a successful transfer of the purchase data and the fifth data.

The purchase data comprise inter alia information regarding the kind and the amount of the products to be purchased in the situation in which the purchase concerns various products and/or various numbers thereof. For example two tickets from lottery A, three tickets from lottery B, etc.

The data relevant to the user that have been generated during the purchase transaction are presented to the user via the data output unit, for example via a screen or a display. The data input unit comprises a keyboard, a touchscreen or the like, by means of which the user can enter data relating to the purchase transaction at the reverse vending machine.

In other words, the method according to the invention makes it possible to make part of a credit value or the entire credit value calculated by the reverse vending machine of an amount of packaging material from a user taken in as a whole by the reverse vending machine, supplemented with an additional payment, if necessary, available for a purchase transaction. This makes it possible to use the method according to the invention for a larger variety of purchases and purchase amounts, using a single operation for returning packaging items, in comparison with the prior art method for making purchases with the credit calculated by the reverse vending machine.

According to an embodiment of the invention, a menu for menu-driven initiation of the purchase transaction by the user via the data input unit and generation of the purchase data and the second data is presented to a user by the data output unit under the control of the data processing unit.

Via this menu the user can choose between, for example, the purchase of different products having different prices or of a number of the same products. In the case of the purchase of a lottery ticket, the user can for example opt to buy a number of tickets, to buy tickets having different prices, to buy tickets from different lotteries, etc. Instead of purchasing a lottery ticket it may also be considered, for example, to purchase one or more admission tickets having the same price or different prices, etc.

According to another embodiment of the invention, in order to minimize the total amount of time needed by the reverse vending machine for taking in packaging items and finalizing the purchase transaction, the data output unit presents a menu preselection for a purchase transaction on the basis of the first data under the control of the data processing unit.

Such a “preselection” may be based on the value of the credit represented by the first data, on frequently purchased products, on action products, on products which are in short supply, etc.

In a preferred embodiment of the invention, which is in particular aimed at accelerating the entire transaction process at the reverse vending machine, the intake unit is arranged to generate, during the taking in of packaging items, first sub-data representative of a first sub-value, expressed in a currency, corresponding to a sub-amount of packaging items taken in from a user, wherein the data output unit presents a menu selection for a purchase transaction on the basis of the first sub-data under the control of the data processing unit, which menu selection can be adaptively changed in dependence on a sub-amount taken in.

That is, while the packaging items are being taken in, the reverse vending machine automatically informs the user already about possible purchases to be made with the deposit credit built up so far. The user can in that case already make a choice regarding a possible purchase while packaging items are being taken in and, once the entire amount of packaging items from the user in question have been taken in, he can make a choice regarding whether or not to make a purchase and, if desired, which purchase. Of course it remains open to the user to make a different choice independently thereof.

Accelerating the total production process of the reverse vending machine, i.e. from the moment the taking in of packaging items commences up to and including the delivery of the purchase, contributes in particular towards providing a user-friendly purchase transaction and preventing long waiting times and waiting queues at a reverse vending machine according to the invention.

Within the framework of the invention, the term deposit voucher is understood to include a paper voucher, for example, with a credit value printed thereon, for example in the form of a bar code or other code, as well as, for example, a voucher to be reproduced on, for example, the screen of a mobile telephone or other electronic information carrier in a readable (graphic) or electronic form to be remote read, if desired. Preferably, such a voucher provided by the data output unit in case a credit is to be paid out to the user comprises a transaction identification or transaction ID generated by the data processing unit.

This transaction ID is inter-alia used in registering the data transactions and data transfer carried out in relation to a respective purchase. The registration has the advantage that a reconstruction can take place in case of a lack of clarity in the execution of the purchase, and that it is exactly known which products are purchased via which reverse vending machine.

For business reasons, the invention also provides for the transfer of the first, second, third and fourth data of a respective purchase transaction with a transaction ID generated by the data processing unit to a POS of an operator of the reverse vending machine under the control of the data processing unit.

The credit corresponding to the first data and the credit corresponding to the fourth data are preferably administered by a respective shopkeeper or enterprise, who or which also issues and receives a deposit voucher and operates a reverse vending machine or several reverse vending machines. Within the framework of the purchase transaction, a user has a claim on the shopkeeper or the enterprise to the amount of the fifth credit value. A payment transaction, being a cash payment or an electronic giro payment, will then result in a data transaction with a data file administered by the shopkeeper or the enterprise, whose data represent credit values in a respective currency.

According to an embodiment of the method according to the invention, the first, second, third and fourth data are transferred to the POS via an intermediary or clearinghouse, and the purchase data and the fifth data, together with the transaction identification, are transferred to the supplier of the purchase via the clearinghouse.

The clearinghouse arranges for the registration of the transactions, the menu selection of the purchases, the purchases that are possible, etc. The clearinghouse is to that end equipped with suitable computers or servers and the like for processing the data.

In an embodiment, the data processing unit is operated by the clearinghouse. The data processing unit may be integrated in the reverse vending machine or be remotely connected thereto as a separate unit, for example via a data communication link with the various units of the reverse vending machine, POS, etc, which may be a permanent data communication link or a link to be set up for each individual case.

According to the method according to the invention, in order to prevent credits being paid out wrongly, the pay-out transaction is only initiated after a successful purchase transaction. A successful purchase transaction comprises the actual delivery of a purchased product.

In particular in the case of an unsuccessful purchase transaction, the first data are, according to the method of the invention provided, in the form of a voucher with a first credit value represented by the first data, and the fourth credit value formed by a payment transaction is paid out in accordance with the respective form of the payment transaction. That is, in the form of a cash, giro or electronic payment, depending on the type of payment transaction effected in relation to the purchase. It is noted that it is also possible to pay out the entire fifth credit value in the form of a voucher. A payment in cash money or a payment in the form of a voucher makes it possible to carry out the entire transaction anonymously, that is, without the user's identification data needing to be known.

According to the invention, the purchase data comprise data regarding the identity of a user, called ID data, received by the data processing unit, not only in order to realise a reliable purchase, but also, for example, in the case of purchases in connection with which certain requirements are or may be made, for example regarding a user's age.

These ID data can be entered by the user in various ways known per se in practice, for example by means of an electronically readable identity card, via telephone number identification and/or by registration in advance by means of a momentary registration upon entering into the purchase transaction and a suitable password or a so-called PIN code. In the case of the purchase of a lottery ticket, for example, having ID data available makes it possible to inform a respective buyer of a prize he has won. The reverse vending machine may to that end be provided with a special ID input unit, or the data input unit is suitable for entering ID data. In the extreme case, if the ID data do not meet the requirements made thereof, the purchase transaction can be refused and only a deposit credit voucher will be furnished.

In an embodiment of the invention, the delivery of the purchase comprises inter alia the delivery of a paper item representing a certain value, such as a lottery ticket, an admission ticket and the like, by the delivery and confirmation unit under the control of the data processing unit. The electronic exchange with user equipment of data identifying a respective purchased product under the control of the data processing unit, and the delivery of products relating to the purchase, among which products in kind and/or cash prizes.

In a preferred embodiment of the invention, for use in purchasing products such as lottery tickets, admission tickets, credits on prepaid phone cards and the like, the method according to the invention comprises the delivery of the purchase by printing, by the delivery and confirmation unit, of a purchased paper item representing a certain value, such as a lottery ticket, an admission ticket, etc.

In the case of a lottery purchase, information about a prize that has been won can be made known in various ways, for example via the data output unit directly after the purchase or via a draw result of a ticket, for example by scanning or entering a ticket number, via a list of winning numbers, via the Internet or other media.

In the case in which suitable ID data of a user are known, the method according to the invention further provides that the delivery of the purchase comprises the electronic exchange of data identifying a respective purchased product under the control of the data processing unit. Information about prizes that have been won or the like can in that case be specifically communicated to the user in question via the ID data, if desired.

In the case of the purchase of, for example, a lottery ticket, with the prize to be won consisting of an amount of money or of admission tickets, coupons or the like, the invention also provides for the direct delivery of such a prize, providing the lottery ticket being delivered is a winning ticket. The invention is thus suitable for handing out prizes in kind, such as admission tickets, travel tickets, vouchers as well as cash prizes.

When so-called “bearer tickets” are issued, a prize that has been won can be delivered anonymously, i.e. the winners identity need not be known in order for the prize to be paid out. That is, even if the buyer's ID data are not known, the buyer can determine whether his number has come up for a prize upon checking his ticket via the reverse vending machine. Prizes that have been won can also be (partially) paid out in the form of new lottery tickets.

According to the invention, cash prizes can be directly paid out in cash or at the cash desk of a shop or the like, in which case the invention provides a suitable voucher with a credit value. This generally applies in the case of prizes of up to a certain amount of money.

Higher amounts, and also lower amounts, of course, can also be paid out via a bank account of the user or the buyer of the lottery ticket. In that case the users ID data are needed, however. In such a case the data processing unit can be used for settling such a payment order with a lottery organisation or the like.

If users do not wish to enter their ID data, higher prizes can be directly cashed with the lottery organisation, upon presentation of the winning ticket, of course.

The above-described method can be carried out by means of a suitable software application, for example a software application acting as a data processing unit, which is installed on an electronic computer or server. The computer or server can be accessed via the Internet or another communication network, if necessary, in communication with, for example, a desktop computer, a laptop, a mobile telephone, a PDA (Personal Digital Assistant) or the like.

The server in question may the server of a shopkeeper or an enterprise, or a separate server suitable for this purpose, which can enter into communication with the server of a respective shopkeeper or enterprise, inter alia for verifying the validity of a voucher.

A buyer can in that case enter the relevant data of a voucher handed out by a shopkeeper or an enterprise within the framework of a discount action or, for example, a voucher handed out by a reversing vending machine, such as a unique voucher number, the name and/or the address of the shopkeeper or the enterprise, identification and/or security codes on the voucher, etc, for example at home on his desktop computer or on his mobile telephone or the like.

If the first value, that is, if the first data represent a credit value which is higher than the second value of the second data or the purchase amount, the credit to be paid out, that is the third (credit) value represented by the third data, can also be printed on a printer connected to the desktop computer, if necessary. In the case of, for example, a mobile telephone, a laptop, a PDA or the like, the voucher can also be graphically displayed on the screen of the device in question.

As an alternative, the third credit value represented by the third data can be deposited on a user's bank account via a giro transaction. Preparing a voucher is no longer necessary in that case.

In the case that the first value does not suffice for a purchase, a user can generate the fourth credit value by means of a giro transaction from his desktop computer, laptop, mobile telephone or the like, to which end any known software application for giro transactions can be used. This is only possible, of course, if a user has such facilities at his disposal.

According to a second aspect of the invention, there is provided a reverse vending machine for taking in packaging items and initiating a data transaction in relation to a self-service purchase, called a purchase transaction, which reverse vending machine is provided with an intake unit for taking in packaging items and for generating first data representative of a first value, expressed in a currency, which corresponds to an amount of packaging items taken in from a user, a data input unit for user initiation of the purchase transaction and for generating purchase data, which purchase data identify a respective purchase, and second data, which second data represent a second value, expressed in the currency in question, of the purchase in question, wherein the purchase data and the second data are generated on the basis of a purchase order entered by a user via the data input unit, a data processing unit operatively connected to the intake unit and the data input unit, and a payment unit, a purchase delivery and confirmation unit and a data output unit, operatively connected to the data processing unit.

The data processing unit is arranged for:
generating third data, on the basis of the first data and the second data, if the second value is smaller than the first value, which third data represent a third value expressed in the currency in question;
initiating, on the basis of the third data, a data transaction in relation to a credit payment, called a pay-out transaction, which pay-out transaction comprises the provision of the third data as first data for a further purchase transaction or of a credit in the currency in question to be paid out via the data output unit;
generating fourth data, on the basis of the first data and the second data, if the second value is higher than the first value, which fourth data represent a fourth value expressed in the currency in question;
initiating, on the basis of the fourth data, a data transaction in relation to a payment, called a payment transaction, which payment transaction comprises the processing by the payment unit of a payment by the user in the form of a cash payment or an electronic payment corresponding to the fourth value;
generating fifth data by forming fifth data from the first data or from the first data and the fourth data, which fifth data represent a fifth value, expressed in the currency in question, corresponding to the second value;
transferring the purchase data and the fifth data to a supplier of the purchase;
confirming and delivering the purchase, by the delivery and confirmation unit, in case of a successful transfer of the purchase data and the fifth data, and
outputting data via the data output unit.

The data processing unit, such as a computer or data processor, may be provided with suitably programmed software, in any suitable programming language, for carrying out the above functions. It will be understood that some functions can be realised both in software and in hardware, or in a combination of both.

The intake unit for taking in packaging items may be an intake unit as known per se in the art, capable of counting packaging items such as empty bottles or the like, determining the shape or origin thereof and calculating a total deposit credit in a respective currency. For the skilled person this needs no further explanation.

The data input unit has the shape of, for example, a keyboard, a touchscreen or the like, via which a user can enter an order for initiation by the reverse vending machine of a purchase transaction.

The data processing unit and the data output unit are preferably arranged to present a menu to the user, under the control of the data processing unit, for menu-driven initiation of the purchase transaction by the user via the data input unit and generation of the purchase data and the second data. The data output unit is in that case in the form of a graphic display unit, such as a graphic display or a monitor or the like.

In order to have the production process take place as efficiently and quickly as possible, the reverse vending machine according to the invention is arranged to generate, through its intake unit, first data representative of a first sub-value, expressed in a currency, during the taking in of packaging items, which sub-value corresponds to a sub-amount of packaging items taken in from a user, whilst the data output unit and the data processing unit are arranged to present a menu selection for a purchase transaction on the basis of the first sub-data under the control of the data processing unit, and for adapting the menu selection to a sub-amount taken in.

In an embodiment of the invention, the data output unit comprises a printer for providing a credit to be paid out in the form of a paper voucher and/or a wireless transceiver for providing an “electronic” voucher, for example for being displayed on the screen of a mobile telephone or the like.

In order to be able to make purchases at a value higher than the first credit value according to the first data, the payment unit may be equipped for additional cash payment in coins or banknotes and/or as a point of payment terminal for electronic or giro payment, as already discussed in the foregoing.

In another embodiment of the invention, the reverse vending machine is also provided with a data transmission unit for internal and/or external data communication of the reverse vending machine, such as transceivers that are available in practice, which operate according to communication protocols that are known per se, via wired and/or wireless data links and networks.

External data transfer inter alia comprises the transfer of the purchase data and the fifth data of the purchase to a supplier or vendor, a shopkeeper or POS, or a clearinghouse and, if necessary, the first up to and including the fourth data of a purchase transaction, in combination with a specific transaction identification.

In the case of reverse vending machines arranged for the purchase of lottery tickets, admission tickets, credits on prepaid telephone cards etc, the unit for delivering and confirming a purchase may consist of one or more printers, using suitable paper, if desired, for printing a lottery ticket or an admission ticket or the like. In the case of electronic delivery, suitable techniques and means for data transfer by means of an electronic device can be used, for example wireless radio transceivers or infrared transceivers and the like, for example having a limited local range, for providing an “electronic” lottery ticket or admission ticket or the like, for example for display on the screen of a mobile telephone or the like.

In another embodiment of the invention, the delivery and confirmation unit is also used for delivering products relating to the purchase, among which products in kind and/or cash prizes. That is, in the case of the purchase of, for example, a lottery ticket, with the prize to be won consisting of an amount of money or admission tickets, vouchers or the like, the invention also provides for the direct delivery of such a prize, providing the lottery ticket being delivered is a winning ticket. All this as explained in more detail in the foregoing.

The reverse vending machine according to the invention thus functions as a completely unmanned, automatic station for self-service purchases (“self-service”), which can also independently pay out a prize that has been won, inter alia when used for lotteries.

In an embodiment of the reverse vending machine, the data input unit is also arranged to receive data regarding the identity of a user, called ID data. A separate ID input unit may be used, if necessary. The ID data may for example be identification data on a data carrier, such as an identification card or the like, or be obtained via any other means suitable for identification, among which video cameras with automatic face recognition or manual recognition by a person trained for this purpose.

The invention further provides a registration unit for registering data transactions and data transfers that have been carried out. Registration units suitable for this purpose, whether or not incorporated in the reverse vending machine or disposed remote therefrom, are generally known in practice and need not be explained to those skilled in the art.

According to a third aspect of the invention, there is provided a data processing unit arranged for use with a reverse vending machine and a method as described in the foregoing.

According to a fourth aspect, the invention comprises a computer programme product comprising programme code stored on a computer-readable medium, which computer programme product causes the computer to function as a data processing unit in the method described in the foregoing, if the computer programme product is loaded in the working memory of a computer and carried out by the computer.

The medium may be any medium for data storage, such as memory sticks, CDs, DVDs, or devices and signals for downloading data.

Instead of an independent programme or an independent application, the invention also provides a computer programme product as discussed above, which is arranged to incorporate the programme code in a computer application for jointly carrying out the programme code and the computer application in question. For example a computer application for calculating a credit of packaging items taken in by the intake unit of the reverse vending machine.

The invention will now be further discussed in detail within the framework of using a deposit credit obtained by returning empty packaging items for making a purchase at a reverse vending machine provided with the aforementioned units. The skilled person will appreciate that some units may also be integrated into a single functional unit.

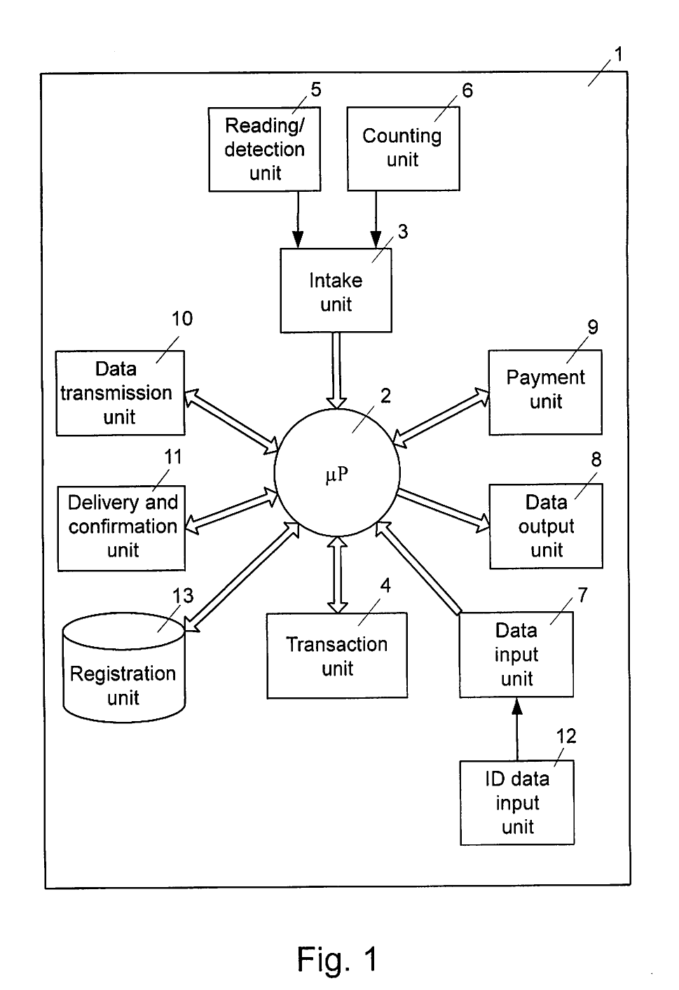

FIG. 1 is a block diagram showing an embodiment of a reverse vending machine according to the invention.

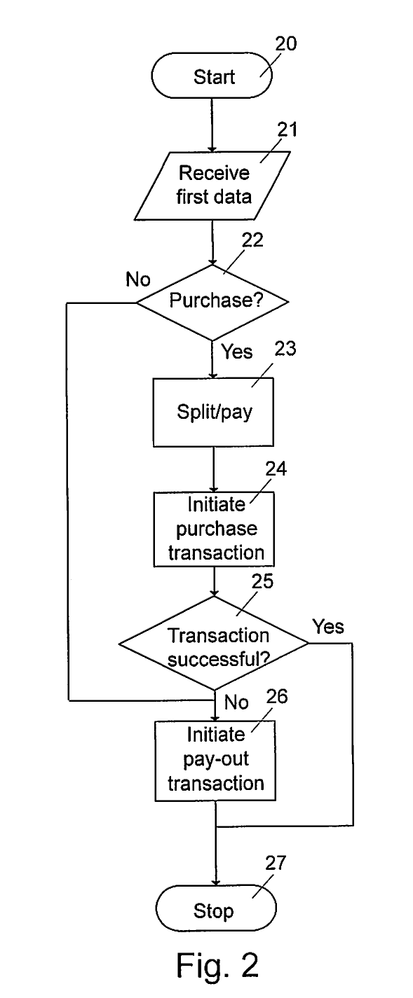

FIG. 2 is a flow diagram showing the general principle of initiating a purchase transaction at a reverse vending machine as shown in FIG. 1, using the method according to the invention.

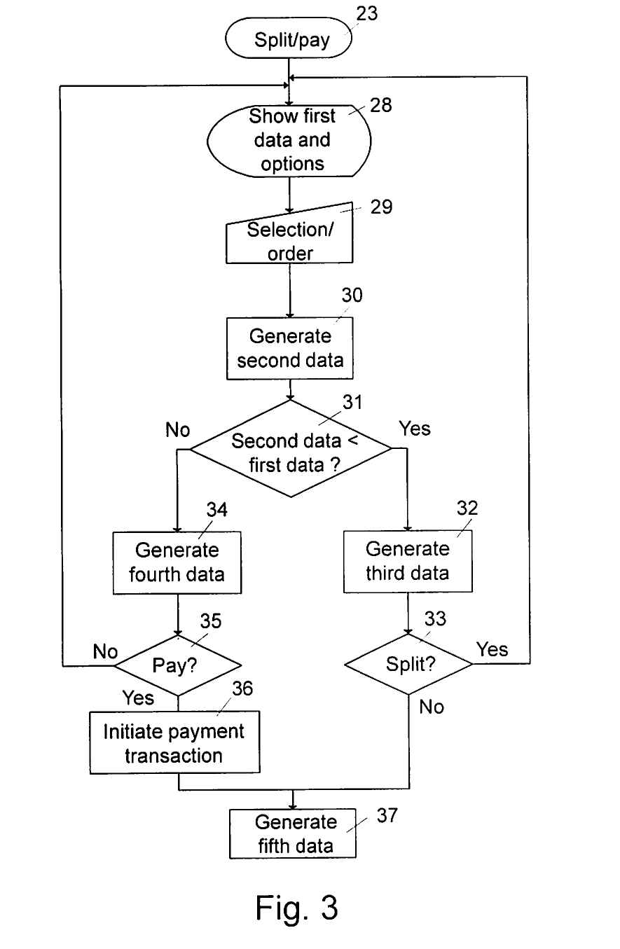

FIG. 3 is a flow diagram showing an embodiment of the initiation of a purchase transaction in accordance with the method of the invention.

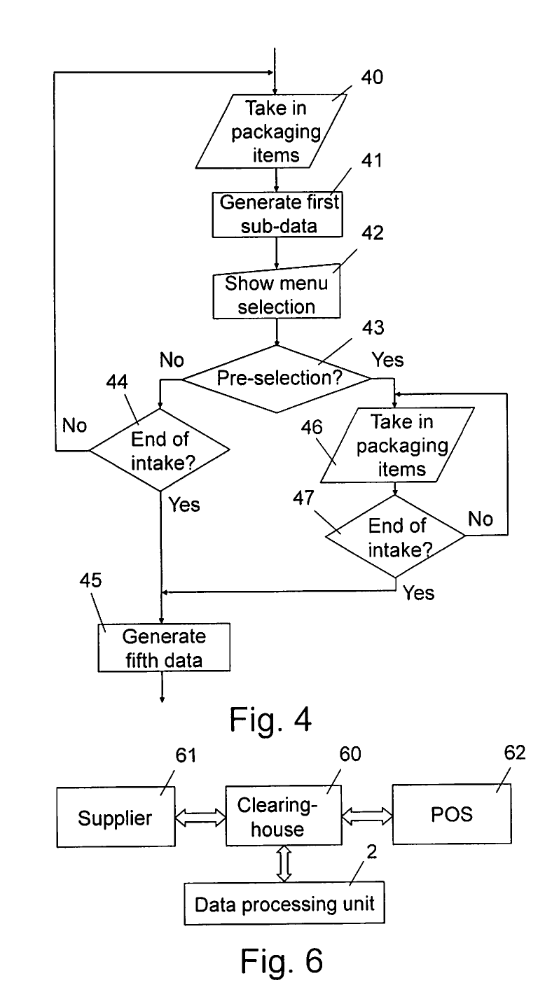

FIG. 4 is a flow diagram showing an embodiment of the initiation of a purchase transaction with a menu selection during the intake of packaging items in accordance with the method of the invention.

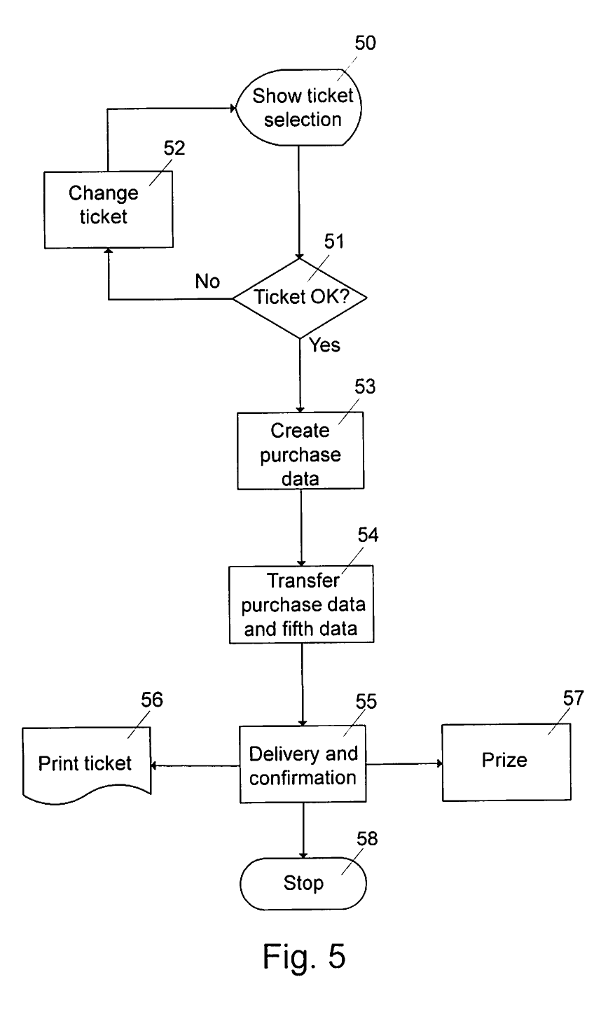

FIG. 5 is a flow diagram showing an embodiment of the execution of a purchase transaction, using the method according to the invention.

FIG. 6 schematically shows a possible data exchange between various entities involved in a purchase transaction.

Reference numeral 1 in FIG. 1 indicates an embodiment of a computer-controlled reverse vending machine according to the invention, which is provided with a data processing unit 2, such as a computer or a microprocessor or the like.

The reverse vending machine 1 comprises an intake unit 3 and, connected thereto, a reading or detection unit 5, such as an optical reader, for example a bar code reader or an electronic reader, for example an RFID reader, for detecting and recognising packaging items, such as bottles, crates and the like, presented to the reverse vending machine 1 by a user via the intake unit 3. A counting unit 6 counts the amount of packaging items taken in and determines, on the basis of the result from the detection unit 5, the value, expressed in a currency to be determined, which the amount of packaging items taken in represents. Within the framework of the invention, this value is referred to as first data or first (credit) value or deposit credit (value). The first data are transferred from the intake unit 3 to the data processing unit 2. Furthermore, a transaction identification, transaction ID, is linked to the data for uniquely identifying the transaction in question. This transaction ID may be provided by the intake unit 3, by the data processing unit or by a transaction unit 4.

The transaction unit 4 is provided for activating and carrying out various transactions to be initiated under the control of the data processing unit 2. The transactions to be carried out within the framework of the invention inter alia comprise a purchase transaction, a payment transaction and a pay-out transaction. The transaction unit 4 comprises the required components and interfaces for data transaction with the data processing unit, as known to the skilled person.

Via the transaction unit 4 a transaction can also be carried out with a server and/or Point Of Sale, POS, of a participating shopkeeper or enterprise, inter alia for exchanging data regarding the validity and testing the validity of packaging items or the like presented to the reverse vending machine 1, or a transaction with an entity for settling payments and the like.

A data input unit 7, such as a keyboard, a touch screen and the like, is provided for the user to communicate orders and the like to the data processing unit 2, for example signalling that the feeding of packaging items to the intake unit 3 is complete, making a choice between making a purchase or receiving a usual deposit credit voucher, etc.

Reference numeral 12 indicates a unit for inputting identification data, called ID data, which is linked to the data input unit 7 or forms part thereof. This ID input unit 12 may inter alia comprise a data card reader, (a) reader(s) for biometric data, a camera and the like. The data input unit 7 and the ID input unit 12 may also be arranged for remote reception of orders and data from a mobile telephone, a PDA (Personal Digital Assistant) or the like.

A data output unit 8 is connected to the data processing unit 2 for providing information to a user. The data output unit 8 may comprise any data output technology that is known in practice, such as a screen, a printer, an electronic data output unit 4 for wired or wireless data transfer to a mobile telephone, a PDA, a data card, etc.

Reference numeral 9 comprises a payment unit for carrying out a payment and/or a pay-out action, such as a payment and/or pay-out action in cash money (coins or banknotes) or a giro payment. A payment or pay-out transaction initiated by the data processing unit 2 is settled via the payment unit 9 under the control of the transaction unit 4. A payment unit 9 suitable for the purpose of the invention is known per se in practice. It will be understood that the payment unit 9 may also be formed by separate payment means and separate pay-out means.

Furthermore, a data transmission unit 10 is provided for providing the required information about the purchase in question and the payment thereof to a supplier of a purchase, for example a lottery organisation.

A delivery and confirmation unit 11 is provided for delivering a purchase. The specific embodiment of the delivery and confirmation unit 11 depends on the purchase to be delivered. In the case of lottery tickets, admission tickets, vouchers or other coupons, the delivery and confirmation unit may comprise a suitable printer or electronic delivery means. The delivery and confirmation unit 11 may for example also comprise mechanical means for delivering products stored in a storage. It is noted that the delivery and confirmation unit 11 may also cooperate with the data output unit 8 for delivering a purchase and/or a further product related to the purchase, such as a prize that has been won by taking part in a lottery.

A registration unit 13 is connected to the data processing unit 2 for registering the various transactions, the transaction ID and the data transfer and the like. The registration unit 13 is preferably locally provided in the reverse vending machine 1, but it may also be disposed remote therefrom, and be connected to the data processing unit via a suitable data link.

The reverse vending machine 1 is generally disposed in a shop or at another suitable location where it is desirable that packaging or containers can be taken in. The reverse vending machine 1 can operate as a completely unmanned unit.

Several of the aforesaid units may be incorporated in the reverse vending machine 1 either as fixed or as detachable modules. The latter option makes it possible to provide a reverse vending machine only with those functions that are required in a given situation or for a given application.

Furthermore it will be apparent to those skilled in the art that the functions performed by the various units can also be combined in one unit, if desired.

Let us now consider the flow diagram of FIG. 2, which shows the steps performed by the reverse vending machine 1 under the control of the data processing unit 2 when a purchase transaction is carried out using the method according to the invention. In the present and the following flow diagrams, the transactions take place in the sequence from the top to the bottom, seen in the drawing. A different sequence is indicated by a respective direction arrow.

Although this is not explicitly shown and described hereinafter, all the transactions carried out in the method according to the invention and the data transfer are stored in the registration unit 13, addressed by the transaction ID. On the basis of this information it can be readily checked whether a transaction has been correctly carried out, so that a recovery possibility will be available if it appears afterwards that mistakes have been made.

A purchase transaction is started, block 20 “Start”, with the intake by the intake unit 3 of an amount of returnable packaging items presented by a user, which packaging items are detected via the detection unit 5 and which, via the counting unit 6, lead to first data representing a first value, expressed in a specific currency, which data are received by the data processing unit 2, block 21 “Receive first data”. During this process, also the transaction ID is generated.

Via the data output unit 8, the user is informed of the credit value of the first data or the deposit credit value of the amount of packaging items handed in by the user. This is for example done by displaying the value on a screen.

Subsequently it is verified whether the uses wishes to effect a purchase transaction or not, which the user can indicate, for example, by operating a key or a button on the data input unit 7, block 22 “Purchase transaction?”.

If the user does not wish to effect a purchase transaction, result “No” of the check in block 22, a purchase transaction is not carried out, but the deposit credit according to the first data is paid out to the user, block 26 “Initiate pay-out transaction”.

If the user does wish to make a purchase, result “Yes” of the check in block 22, and has made a choice, via the data input unit 7, which leads to a purchase order and purchase data, for example on the basis of a purchase menu presented by the data output unit 8, the method according to the invention provides that a procedure is started for splitting the first credit value into a value corresponding to the purchase, called second value, represented by second data, either for paying out a remainder of the first (credit) value, a third value represented by third data, or for supplementing the credit by making a payment to the amount of a fourth value represented by fourth data, block 23 “Split/pay”.

The result of the procedure in block 23 are fifth data, which represent a fifth value by means of which the purchase transaction is initiated, block 24 “Initiate purchase transaction”. In case no transaction costs are charged, the fifth data represent the same value as the second data. Preferably, the values are expressed in one and the same currency.

In block 25 “Purchase transaction successful”, the data processing unit 2 checks whether a purchase has been successfully completed. A successful purchase eventually consists of a delivery of the product or the purchased item in accordance with the purchase data and a confirmation of the delivery by the delivery and confirmation unit 11.

If the purchase transaction is successful, result “Yes” of the check in block 25, the transaction can be stopped, block 27 “Stop”. In the unhoped-for situation that the transaction is not successful, for example due to interruptions in the data transfer, trouble in the data output unit 8 and the like, that is, result “No” of the check in block 25, the method according to the invention provides that the fifth credit value created for the purchase is paid back to the user, as represented by the fifth data, block 26 “Initiate pay-out transaction”.

The pay-out transaction is controlled by the data processing unit 2 via the transaction unit 4 and the payment unit 9. A pay-out action may comprise the furnishing of a voucher having the first or the total fifth credit value, via the data output unit 8, by cash repayment via the payment unit 9, by non-cash repayment, etc. After completion of the pay-out transaction, the action can be terminated, block 27 “Stop”.

Although not explicitly shown, a user can be informed of the reason of an unsuccessful purchase transaction, etc, via the data output unit 8.

FIG. 3 shows in more detail, in flow diagram form, the procedure for splitting/paying according to the method of the invention in block 23.

The splitting or reducing of a first credit value represented by the first data depends on the price or the cost of the purchase in question and possible transaction costs or the like. It is assumed hereinafter that no transaction costs will be charged to the account of the user. Any transaction costs may also be settled separately between a supplier and a vendor (shopkeeper) of a product to be purchased or via an adjustment of the fifth data for the eventual purchase. This aspect will not be discussed in more detail within the framework of the present description.

To enable a user to select a purchase, the data processing unit 2 first communicates the first deposit credit value according to the first data and selection options to the user under the control of a menu via the data output unit 8, for example on a display or other graphic interface, block 28 “Show first data and options”. The options may comprise several products to be purchased, such as tickets for taking part in a lottery, admission tickets and other products, for example small surprise gifts, toys or the like, in various combinations.

The user makes his selection known, using the data input unit 7, in the form of a purchase order, block 29 “Selection/order”, on the basis of which the data processing unit will generate second data representing a second value in a currency suitable for purchase, preferably the same currency as that in which the first credit value is represented, block 30 “Generate second data”. Furthermore, purchase data representing the desired purchase will be generated.

Subsequently it is checked whether the credit value represented by the first data suffices for paying for the selected purchase, block 31 “Second data<first data?”.

If the result of the check in block 31 is “No”, the data processing unit 2 will generate fourth data, which represent a credit value to be paid extra to the amount of the second value minus the first value, preferably expressed in the same currency as these values. The user is now asked via the data output unit 8 whether he wishes to pay the credit due for the purchase, block 35 “Pay?”. If the answer is “Yes”, a payment transaction will be initiated via the transaction unit 4 and the payment unit 9, block 36 “Initiate payment transaction”. The payment transaction may comprise the entry of an identification, ID, of the user, for example via the ID input unit 12. If the user does not wish to play, result “No” of block 35, the first (credit) value and selection options for a purchase will be shown again, block 28. The user can in that case change his purchase, if desired, so that a purchase can take place for which the deposit credit, i.e. the first value, suffices. A limit can of course be set to the number of times referring back is possible, in which case the transaction will be stopped (not shown) when the limit is exceeded.

As a result of a successful payment transaction, the data processing unit 2 will eventually generate fifth data, block 37 “Generate fifth data”, which data represent a fifth value for payment of the purchase. The fifth (credit) value is the sum of the first and the fourth value.

If the first credit value suffices, or is too high for paying for a selected purchase, result “Yes” of the check in block 31, the data processing unit will generate third data, block 32 “Generate third data”, which represent a remaining credit to the amount of the first credit value minus the second value, preferably expressed in the same currency as these values.

Subsequently the user is asked via the data output unit 8 in block 33 “Split?” whether he wishes to use the remaining credit for another purchase transaction. If the user selects “No”, the fifth data representing a fifth credit value equal to the first value minus the second value can be generated in block 37. If the user selects “Yes”, the user is again presented with a selection for purchasing another product, with the first data in block 28 being equal to the third data of block 32. Also in the case of this referral back a limit can be set as regards the number of times referring back is possible. Also in the case that the third credit value is zero, the user can be asked whether he wishes to make another purchase, in which case he will have to make a supplementary payment in block 35, of course.

In the case of a remaining credit, i.e. if the third data represent a positive credit value, the remaining credit is paid out to the user in a suitable manner after a successful purchase transaction via a pay-out transaction, as described in the foregoing.

As discussed in the introduction, the invention, according to another embodiment thereof, provides that in order to accelerate the purchase transaction or in order to minimize the time the reverse vending machine needs to take in packaging items and complete the purchase transaction, the data output unit presents a pre-selection for a purchase transaction on the basis of the first data under the control of the first data processing unit.

Such a “preselection” may be based on various criteria, among which the value of the credit represented by the first data in relation to the cost of a respective purchase or product, on products being in frequent demand, on action products, on products that are in short supply, etc.

FIG. 4 schematically illustrates in the form of a flow diagram an embodiment in which in block 28 in FIG. 3, first sub-data representative of a first sub-value, expressed in a currency, corresponding to a sub-amount of packaging items taken in from a user are generated, block 41 “Generate first sub-data”, and presented to the user during the taking in of packaging items by the intake unit 3, block 40 “Take in packaging items”. These first sub-data may be generated by the counting unit 6, for example. The data output unit 8 will then present a menu selection comprising an option or various options or (a) pre-selection(s) for a purchase transaction on the basis of the first sub-data and one or more of the aforesaid criteria under the control of the data processing unit 2, block 42 “Show menu selection”.

The user is given the possibility to confirm a pre-selection being displayed, block 43 “Pre-selection?”. If the result of the check in block 43 is “No”, this menu selection is automatically adapted, continuously if possible, to the value of a sub-amount of packaging items taken in, block 44 “End of intake?”, result “No”, until the total amount of packaging items has been taken in, result “Yes” of the check in block 44. Following this, the first data for the total amount of packaging items taken in are generated, block 45 “Generate first data”. Then the user can make a selection/order according to block 29 in FIG. 3.

If the user already makes a selection for a purchase in block 43 before all his/her packaging items have been taken in, result “Yes” of the check in block 43, the remainder of he packaging items will be taken in without a further menu being displayed, block 46 “Take in packaging items” and block 47, “End of intake?”, result “No”. At the end of the intake session of the packaging items in block 47, result “Yes”, the total first data are calculated again in block 45, and the pre-selection then only needs to be confirmed in block 29.

As already described in the foregoing, further data, called purchase data in the foregoing, are generated upon making a selection in block 29, which data identify a respective purchase or purchases. An example of this is shown in FIG. 5.

FIG. 5 shows in flow diagram form the course of a self-service purchase transaction as initiated in block 24 of FIG. 2. In this case the product to be purchased is a ticket for taking part in a lottery. Although this is not explicitly mentioned hereinafter, an identity check of the user, via the ID input unit 12, may underlie this transaction.

Via the data output unit 8, under the control of the data processing unit 2, the user is again presented with a menu for selecting a specific lottery ticket or ticket number, block 50 “Show ticket selection”. Instead of a graphic presentation, block 50 may also comprise an audio presentation. In block 51 “Ticket OK?”, the user is asked whether the ticket being shown corresponds to his selection. If “No” is selected, block 52 “Change ticket” will provide a possibility of making a further selection via the data output unit 7. If “Yes” is selected, purchase data identifying the selected ticket will be created, block 53 “Create purchase data”.

These purchase data, together with the fifth credit value, are then transferred to a supplier of the ticket, for example a lottery organisation, via the data transmission unit 10, as shown in block 54 “Transfer purchase data and fifth data”.

Then a delivery and confirmation transaction with a supplier is initiated, block 55 “Delivery and confirmation”, and the ticket or tickets is (are) delivered to the user, for example by printing the same on paper via the data output unit 8, or electronically, by displaying the same on a mobile telephone or the like, block 56 “Print ticket”. The transaction can then be terminated, block 58 “Stop”.

The invention also provides that a prize that has been won can be paid out directly, block 57 “Prize”. Prizes to be paid out directly may be admission tickets, vouchers, small physical products, small or large cash prizes or the like, which can be provided via a suitable data output unit 8, as discussed in the introduction.

From the foregoing it will be understood that the invention is not limited to products such as a lottery ticket or tickets. Furthermore, the first up to and including the fifth data may be processed in combination with each other. For a correct understanding of the invention it has been opted, however, to use separate designations for the respective data. The claims also comprise the use of such combined data.

In an embodiment of the invention, all the relevant data that represent a value, the purchase data and the transaction ID, are transferred, via a server of a clearinghouse or intermediary, to the supplier of the purchase and the POS or server of a shopkeeper who has received the deposit credit paid by a user at the time of the sale of the packaged goods and, if necessary, via an intake centre for packaging items and the manufacturer thereof.

FIG. 6 illustrates a possible data transaction between a server 60 of a clearinghouse, which is in communication with or may have the functionality of the data processing unit 2, and a server 61 of a supplier of a purchase and the POS or server 62 of a shopkeeper or other organisation that exploits a reverse vending machine 1 according to the invention. In particular, the fifth data and the purchase data are exchanged with the server 61 via the data transmission unit 10, and one or more of the first, second, third, fourth, fifth data and the purchase data are selectively exchanged with the server or POS 62. By means of this data exchange, the supplier can book the purchase as sales for its organisation and settle it with the deposit credit previously received from the user.

The reverse vending machine 1 can be provided as an independent unit for self-service purchases, but it may also be integrated or combined with another device. The invention therefore also comprises a reverse vending machine for packaging items of products, which is arranged for calculating a credit value on the basis of packaging items taken in and which is provided with a data processing unit 2 and/or a programme code for carrying out the method according to the invention, as for example provided via a computer programme product comprising programme code stored on a medium that can be read by a computer, which computer programme product functions to carry out the method according to the invention when the computer programme product has been loaded into the working memory of a computer and is carried out by the computer, possibly in combination with another application.

As already discussed in the introduction, the method according to the invention can also be carried out using a suitable software application, for example a software application installed on a server, which is accessible via the Internet. Such server may be a separate server intended for this purpose, but also, for example, the server used by an enterprise or a shopkeeper in combination with, for example, a server run by a clearinghouse or other intermediary.

For a buyer, access to the software application can be provided via, for example, a desktop computer, laptop, a mobile telephone, a PDA (Personal Digital Assistant) or the like.

A buyer can in that case enter relevant data of a voucher provided by a shopkeeper or enterprise within the framework of a discount action or, for example, by a reverse vending machine, such as a unique voucher number, the name and/or the address of the shopkeeper or the enterprise, identification and/or security codes on the voucher, etc, into the Internet application in question, for example at home on his desktop computer or his mobile telephone.

If the first credit value of the voucher, i.e. the first data, represent a credit value which is higher than the second value of the second data or the purchase amount, the credit to be paid out, that is the third credit value represented by the third data, can be printed by a printer connected to the desktop computer. In the case of, for example, a mobile telephone, a laptop, a PDA or the like, the voucher can be graphically displayed on the screen of the device in question.

Alternatively, the third credit value represented by the third data can be deposited on a user's bank account by means of a giro transaction. Making a voucher is no longer necessary in that case.

If the first value does not suffice for a purchase, a user can generate the fourth credit value by means of a giro transaction from his desktop computer, laptop, mobile telephone or the like, for which purpose any software application that is known per se for giro transactions can be used. This is conditional, of course, on the user having such facilities available.

Many modifications and additions to the above-described embodiments of the invention can be realised by the skilled person without this involving an inventive step. The appended claims are considered to comprise all those alternatives.

1. A method for initiating a data transaction in relation to a self-service purchase, in the form of a purchase transaction, by means of a reverse vending machine for taking in packaging items, wherein said reverse vending machine is provided with an intake unit for taking in packaging items and for generating a first data representative of a first value, expressed in a currency, which corresponds to an amount of packaging items taken in from a user, a data input unit for user initiation of a purchase transaction and for generating purchase data, said purchase data identifying said purchase, and a second data, which second data represents a second value, expressed in said currency, of said purchase, wherein said purchase data and said second data are generated based on a purchase order entered by said user via said data input unit, a data processing unit operatively connected to said intake unit and said data input unit, and a payment unit, a purchase delivery and confirmation unit and a data output unit, operatively connected to said data processing unit, wherein said method comprises carrying out the following steps under control of said data processing unit:
generating a third data, based on said first data and said second data, if said second value is smaller than said first value, wherein said third data represents a third value expressed in said currency;
initiating, based on said third data, a data transaction in relation to a credit payment, in the form of a pay-out transaction. wherein said pay-out transaction comprises provision of said third data as first data for one of a further purchase transaction and a credit in said currency to be paid out via said data output unit;
generating a fourth data, based on said first data and said second data, if said second value is higher than said first value, wherein said fourth data represents a fourth value expressed in said currency;
initiating, based on said fourth data, a data transaction in relation to a payment, in the form of a payment transaction, wherein said payment transaction comprises a processing by said payment unit of a payment by said user in a form of one of a cash payment and an electronic payment corresponding to said fourth value;
generating a fifth data, by forming said fifth data from one of said first data, and said first data and said fourth data, wherein said fifth data represents a fifth value, expressed in said currency, corresponding to said second value;
transferring said purchase data and said fifth data to a supplier of said purchase;
confirming and delivering said purchase, by said delivery and confirmation unit, in case of a successful transfer of said purchase data and said fifth data, and
outputting data via said data output unit.

2. The method according to claim 1, wherein said data output unit presents a menu for menu-driven initiation of said purchase transaction by said user via said data input unit and generation of said purchase data and said second data to a user under control of said data processing unit.

3. The method according to claim 1, wherein said data output unit presents a menu preselection for a purchase transaction based on said first data under control of said data processing unit.

4. The method according to claim 1, wherein said intake unit is arranged to generate, during a taking in of packaging items, first sub-data representative of a first sub-value, expressed in a currency, corresponding to a sub-amount of packaging items taken in from a user, and wherein said data output unit presents a menu selection for a purchase transaction based on said first sub-data under control of said data processing unit, wherein said menu selection is adaptively changed in dependence on a sub-amount taken in.

5. The method according to claim 1, wherein said first, second, third and fourth data of a respective purchase transaction are transferred, together with a transaction identification generated by said data processing unit, to a Point Of Sale (POS) of an operator of said reverse vending machine under control of said data processing unit.

6. The method according to claim 1, wherein said credit to be paid out is provided by said data output unit in a form of a voucher comprising a credit value corresponding to said credit to be paid out, and said a transaction identification generated by said data processing unit.

7. The method according to claim 1, wherein said first, second, third and fourth data are transferred to a Point Of Sale (POS) via one of an intermediary and a clearinghouse, and said purchase data and said fifth data, together with a transaction identification generated by said data processing unit, are transferred to said supplier of said purchase via said clearinghouse.

8. The method according to claim 1, wherein said data processing unit is operated by a clearinghouse.

9. The method according to claim 1, wherein said purchase data comprises data regarding an identity of a user, in the form of ID data, received by said data processing unit.

10. The method according to claim 1, wherein delivery of said purchase comprises one of:
a delivery by said delivery and confirmation unit of a paper item representing a certain value, under control of said data processing unit,
an electronic exchange with user equipment of data identifying a purchased product under control of said data processing unit, and
a delivery of products and/or cash relating to said purchase.

11. The method according to claim 1, wherein in case of an unsuccessful purchase transaction, said data output unit, controlled by said data processing unit, furnishes a voucher comprising a first credit value represented by said first data and said fourth value formed by a payment transaction and a transaction identification generated by said data processing unit.

12. A reverse vending machine for taking in packaging items, wherein said reverse vending machine is provided with an intake unit for taking in packaging items and for generating a first data representative of a first value, expressed in a currency, which corresponds to an amount of packaging items taken in from a user, a data input unit for user initiation of a purchase transaction and for generating purchase data, which purchase data identifies said purchase, and a second data, wherein said second data represents a second value, expressed in said currency, of said purchase, wherein said purchase data and said second data are generated based on a purchase order entered by said user via said data input unit, a data processing unit operatively connected to said intake unit and said data input unit, and a payment unit, a purchase delivery and confirmation unit and a data output unit, operatively connected to said data processing unit, wherein said data processing unit is arranged for carrying out the following steps under control of said data processing unit for initiating a data transaction in relation to a self-service purchase, in the form of a purchase transaction:
generating a third data, based on said first data and said second data, if said second value is smaller than said first value, which third data represents a third value expressed in said currency;
initiating, based on said third data, a data transaction in relation to a credit payment, in the form of a pay-out transaction, wherein said pay-out transaction comprises provision of said third data as first data for one of a further purchase transaction and a credit in said currency to be paid out via said data output unit;
generating a fourth data, based on said first data and said second data, if said second value is higher than said first value, which fourth data represents a fourth value expressed in said currency;
initiating, based on said fourth data, a data transaction in relation to a payment, in the form of a payment transaction, wherein said payment transaction comprises a processing by said payment unit of a payment by said user in a form of one of a cash payment and an electronic payment corresponding to said fourth value;
generating a fifth data by forming said fifth data from one of said first data, and said first data and said fourth data, which fifth data represents a fifth value, expressed in said currency, corresponding to said second value;
transferring said purchase data and said filth data to a supplier of said purchase;
confirming and delivering said purchase, by said delivery and confirmation unit, in case of a successful transfer of said purchase data and said fifth data, and
outputting data via said data output unit.

13. The reverse vending machine according to claim 12, wherein said data processing unit and said data output unit are arranged to present a menu to said user, under control of said data processing unit, for menu-driven initiation of said purchase transaction by said user via said data input unit and generation of said purchase data and said second data.

14. The reverse vending machine according to claim 12, wherein said intake unit is arranged to generate, through its intake unit, first sub-data representative of a first sub-value, expressed in a currency, during taking in of packaging items, which sub-value corresponds to a sub-amount of packaging items taken in from a user, wherein said data output unit and said data processing unit are arranged to present a menu selection for a purchase transaction based on said first sub-data under control of said data processing unit, and for adapting said menu selection to a sub-amount taken in.

15. The reverse vending machine according to claim 12, arranged for delivering said purchase by one of:
a delivery of a paper item representing a certain value, by said delivery and confirmation unit under control of said data processing unit,
an electronic exchange with user equipment of data identifying a respective purchased product under control of said data processing unit, and
a delivery of products and/or cash relating to said purchase.

16. A data processing unit arranged for use with a reverse vending machine and a method according to claim 1.

17. A computer programme product comprising programme code stored on a computer-readable medium, which computer programme product causes a computer to operate as a data processing unit in the method according to claim 1, if wherein said computer programme product is loaded in a working memory of a computer and carried out by said computer.
